(19) United States
(12) Patent Application Publication
(10) Pub. No.: US 2013/0208345 A1
(43) Pub. Date: Aug. 15, 2013

(54) ELECTROPHORESIS DISPLAY DEVICE AND PREPARATION METHOD OF THE SAME

(71) Applicants: Ho-Suk Song, Yongin-si (KR); Hyeon-Jung Yoo, Yongin-si (KR); Young-Seo Yoon, Seoul (KR); Chung-Seock Kang, Yongin-si (KR); Hey-Jin Myoung, Seoul (KR)

(72) Inventors: Ho-Suk Song, Yongin-si (KR); Hyeon-Jung Yoo, Yongin-si (KR); Young-Seo Yoon, Seoul (KR); Chung-Seock Kang, Yongin-si (KR); Hey-Jin Myoung, Seoul (KR)

(73) Assignee: KOLON INDUSTRIES, INC., Gwacheon-si, Gyeonggi-do (KR)

(21) Appl. No.: 13/877,047

(22) PCT Filed: Sep. 30, 2011
(86) PCT No.: PCT/KR11/07262

§ 371 Date: Apr. 19, 2013

(30) Foreign Application Priority Data
Sep. 30, 2010 (KR) 10-2010-0095357

(51) Int. Cl. G02F 1/167

(52) U.S. Cl. CPC G02F 1/167
USPC 359/296; 156/272.2

(57) ABSTRACT

The present invention relates to an electrophoretic display device that includes: first and second substrates separated from each other by a predetermined distance; first and second electrodes formed on one side of the first and second substrates, respectively, and disposed to face each other; a black pattern layer formed on the first electrode; a plurality of partition walls formed between the first and second electrodes, one side of the partition walls on the first electrode being in contact with or overlapped with the black pattern layer; and a slurry of charged white particles filled between the partition walls. The electrophoretic display device can exhibit a high contrast ratio and enhanced visibility to realize high-quality text.

### FIELD OF THE INVENTION

The present invention relates to an electrophoretic display device and a fabrication method thereof, and more particularly to an electrophoretic display device that exhibits a high contrast ratio and enhanced visibility to realize high-quality text, and a fabrication method thereof.

### BACKGROUND OF THE INVENTION

Electronic paper or digital paper, also called “e-paper”, refers to an electronic device capable of being easily carried or moved and opened at any time, like paper books, newspaper, or paper magazines, and able to receive writing like ordinary paper.

Electronic paper takes the form of an electrophoretic display, which holds significant advantages over the conventional flat displays, including flexibility to not be bent out of shape, a far lower production cost, and higher energy efficiency without requiring a separate backlight. Such electronic paper is very definite with a wide viewing angle and is capable of realizing a memory function such that the text does not disappear completely even when the power is switched off.

With these significant advantages, electronic paper can be used in a very wide range of applications, such as e-books or self-updating newspapers having a paper-like side and moving illustrations, reusable paper displays for mobile phones, disposable TV screens, electronic wallpaper, and so forth, with vast potential for market growth.

Based on the display method for implementation, the electronic paper can be categorized into an electrophoretic display, a liquid crystal display, a toner display (QR-LPD: quick-response liquid powder display), and a MEMS (micro-electro-mechanical systems) display. Among these displays, the techniques most approaching commercialization are the microcapsule electrophoretic display and the micro-cup electrophoretic display, both of which use particles as color display elements. Particularly, the micro-cup electrophoretic display is capable of being produced by a roll-to-roll continuous manufacturing process and is thus drawing more attention as a technology suitable for large-scale production.

As for the conventional micro-cup electrophoretic electronic paper, charged white particles move up and down in black ink according to a voltage applied to show light and shadow portions, as shown in FIG. 1. When the conventional micro-cup electrophoretic electronic paper is driven, however, the charged white particles cannot be properly positioned because of the walls of the cell or the forces of attraction which act between the particles, as shown in FIG. 2. In consequence, the electronic paper encounters a difficulty in achieving a high contrast ratio and shows vague representation of the white and black gradient when the display is driven, resulting in poor representation of grays. Furthermore, the micro-cup electrophoretic electronic paper has the charged white particles form a mass on the walls of the cell, consequently causing a reduced contrast ratio and poor representation of light and shade.

Accordingly, there has been a demand for development of electrophoretic displays which overcome the problems with the conventional micro-cup electrophoretic displays and realize a high contrast ratio and enhanced visibility.

### DETAILED DESCRIPTION OF THE INVENTION

### Technical Objectives

It is an object of the present invention to provide an electrophoretic display device that exhibits a high contrast ratio and enhanced visibility to realize high-quality text.

It is another object of the present invention to provide a method for fabricating the electrophoretic display device.

### Technical Solutions

The present invention provides an electrophoretic display device including: first and second substrates separated from each other by a predetermined distance; first and second electrodes formed on the one side of the first and second substrates, respectively, and disposed to face each other; a black pattern layer formed on the first electrode; a plurality of partition walls formed between the first and second electrodes, one side of the partition wall on the first electrode being in contact with or overlapped with the black pattern layer; and a slurry of charged white particles filled between the partition walls.

The present invention also provides a method for fabricating an electrophoretic display device that includes: (a) forming first and second electrodes on the one side of first and second substrates separated from each other by a predetermined distance, respectively; (b) forming a black pattern layer on the first electrode; (c) forming a plurality of partition walls on the first electrode to cause one side of the partition walls on the first electrode to be in contact with or overlapped with the black pattern layer; (d) filling a slurry of charged white particles between the partition walls; and (e) mounting the second substrate to have the second electrode face the first electrode.

Hereinafter, a detailed description will be given of an electrophoretic display device and a fabrication method thereof according to the exemplary embodiments of the present invention.

In accordance with one exemplary embodiment of the present invention, an electrophoretic display device including: first and second substrates separated from each other by a predetermined distance; first and second electrodes formed on one side of the first and second substrates, respectively, and disposed to face each other; a black pattern layer formed on the first electrode; a plurality of partition walls formed between the first and second electrodes, one side of the partition wall on the first electrode being in contact with or overlapped with the black pattern layer; and a slurry of charged white particles filled between the partition walls is provided.

The inventors of the present invention found that using the black pattern layer in place of a black ink and disposing it to be partly in contact with or to overlap the partition walls can prevent white particles from forming a mass on the partition walls and overcome degradation of the contrast ratio potentially occurring in the boundary interface while displaying a white-gray-black gradation, thereby making it possible to provide an electrophoretic display that exhibits a high contrast ratio and enhanced visibility to realize high-quality text.

A driving example of the electrophoretic display device is illustrated in FIG. 3. In the electrophoretic display device, the charged white particles filled between the partition walls move up and down according to the voltage applied, to implement a white-gray-white gradation.

The first and second substrates may be separated from each other by a predetermined distance, for example, from 10 μm to 100 μm. The materials for the first and second substrates are not specifically limited as long as they can be typically used for the substrates of display devices, and may include, for example, PET, PAN, PI, or glass.

The first and second substrates may be formed on one side of the first and second substrates, respectively, and disposed to face each other in the electrophoretic display device. The first and second electrodes may be any electrode known to be used for display devices without any specific limitation. Preferably, at least either one of the first or second electrode is a transparent electrode made of, for example, ITO, SnO₂, ZnO, or IZO (indium zinc oxide). The first and second electrodes may be disposed to face each other at a predetermined distance, for example, from 10 μm to 100 μm.

A black pattern layer, which can be prepared from a black photosensitive resin composition, may be formed on the first electrode. The black pattern layer functions to implement black when the display device is driven. The black pattern layer together with the second electrode and the partition walls defines a space for a cell or a micro-cup of the electrophoretic display device.

The black pattern layer may have a thickness of 0.05 μm to 12 μm, preferably 0.07 μm to 10 μm. In the electrophoretic display device, the blackness can be easily controlled by adjusting the thickness of the black pattern layer. In the case that the black pattern layer is too thin or thick, it can be difficult to represent black or acquire a high contrast ratio. More specifically, an extremely low thickness of the black pattern layer leads to an excessively high absolute value of blackness implemented by the electrophoretic display device, and thus potentially makes it difficult to acquire a high contrast ratio. Particularly, an extremely high thickness of the black pattern layer undesirably provides an insignificant effect of reducing the absolute value of blackness but greatly deteriorates the flexibility of the electrophoretic display device.

The black pattern layer may include a plurality of black patterns that come in different three-dimensional shapes. For example, the black pattern may have two faces parallel to the first electrode, one of which is in contact with the first electrode, and the other of which is in contact with or overlapped with the partition walls, thereby defining the cell or the micro-cup of the electrophoretic display device. The lateral side of the black pattern may be partly overlapped with the partition walls on the first electrode. The lateral side may be of a shape which includes a face perpendicular to the first electrode or an entirely or partly inclined face. Therefore, the black pattern may have a cross-section in the shape of a rectangle, a trapezoid, or a hexagon with two inclined faces, as shown in FIG. 4.

Particularly, when the black pattern includes at least one inclined face, a defined groove may be formed in the portion of the black pattern overlapped with the partition walls. As shown in FIG. 5, the electrophoretic display device which is displaying black has the charged white particles congregate densely around the groove, resulting in the contrast ratio being greatly enhanced. The inclined face of the black pattern may be formed to form an acute angle with the first substrate.

The one side of the partition walls on the first electrode may be formed to by in contact with or overlapped with the black pattern layer. As the partition walls are formed to be in partial contact with or overlapped with the black pattern layer, it is possible to prevent degradation of the contrast ratio potentially occurring in the boundary interface while displaying a white-gray-black gradation and to achieve a high contrast ratio and enhanced visibility.

10% to 70% of the one side of the partition wall on the first electrode may overlap the black pattern layer. In the case that the black pattern has a trapezoidal cross-section, for example, the partition wall may be formed to overlap the black pattern layer as illustrated in FIG. 6.

Further, the partition wall may have a thickness of 5 μm to 50 μm. The thickness of the partition wall means the maximum width of the partition wall perpendicular to the height of the partition wall (for example, the distance between the first and second electrodes).

The partition wall may have a cross-section which comes in different shapes, such as a rectangle, a square, or a trapezoid. The cross-section of the partition wall is preferably trapezoidal as shown in FIG. 7, with a view of enhancing the whiteness on the top of the partition wall while the electrophoretic display device is displaying black.

The electrophoretic display device can have enhanced whiteness by increasing the content of the charged white particles, but almost without degradation of the blackness even when the content of the charged white particles is increased up to a defined level or above, which overcomes the problem with the existing displays in association with the combination of black ink and white particles that possibly deteriorates the blackness by the increased amount of the white particles.

In addition, the electrophoretic display device can have the blackness easily controlled by changing the thickness of the black pattern layer, as a result of which it is possible to provide a modified product with enhanced blackness. Particularly, the contrast ratio can be controlled with ease by changing the shape or the area of the edge portion of the black pattern layer, that is, the portion being in contact with the partition walls on the first electrode.

FIG. 8 is a standard mimetic diagram of the electrophoretic display device; FIG. 9 is a mimetic diagram of an electrophoretic display device with the whiteness enhanced by increasing the content of the charged white particles; and FIG. 10 is a mimetic diagram of an electrophoretic display device with the blackness enhanced by thickening the black pattern.

The slurry of charged white particles means a slurry containing charged white particles and having a defined viscosity. The slurry of charged white particles may include charged white particles and other components, or charged white particles and a rheological fluid.

The charged white particles may include a core of inorganic particles capable of representing white, and a shell coating layer including an organic substance controllable in specific gravity and quantity of electric charge and surrounding the core. The examples of the white inorganic particles used for the core may include TiO₂, MgO, ZnO, CaO, ZrO₂, etc.; and the examples of the organic substance contained in the shell coating layer may include acrylate-based resins, methacrylate-based resins, styrene-based resins, urethane-based resins, silicone-based polymers, melamine resins, mixtures of at least two of these, or their copolymers.

The slurry of charged white particles may include the charged white particles and a rheological fluid, where the volume ratio of the charged white particles to the rheological fluid ranges from 5:95 to 60:40, preferably from 7:93 to 40:60. The rheological fluid may be a solvent having a viscosity of 20 cP or less, preferably a hydrocarbon-based solvent having a viscosity of 20 cP or less.

In accordance with another exemplary embodiment of the present invention, a method for fabricating the electrophoretic display device is provided that includes: (a) forming first and second electrodes on one side of first and second substrates separated from each other by a predetermined distance, respectively; (b) forming a black pattern layer on the first electrode; (c) forming a plurality of partition walls on the first electrode to cause the one side of the partition walls on the first electrode be in contact with or overlapped with the black pattern layer; (d) filling a slurry of charged white particles between the partition walls; and (e) mounting the second substrate to have the second electrode face the first electrode.

As described above, the electrophoretic display device which uses the black pattern layer in place of the existing black ink and has it overlapped with a part of the partition walls on the first substrate can exhibit a high contrast ratio and enhanced visibility to realize high-quality text.

The step of forming the first and second electrodes on the one side of the first and second substrates, respectively, may employ any typical method and apparatus known to be used to form electrodes for display devices without any specific limitation.

The step of forming a black pattern layer on the first electrode may include: applying a black photosensitive resin composition onto the first electrode; and conducting exposure, development, and washing steps on the applied black photosensitive resin composition to form a plurality of black patterns. A mimetic diagram showing the step of forming a black pattern layer is illustrated in FIG. 11.

The black photosensitive resin composition may be applied onto the first electrode by a coating method, such as spin coating, bar coating, screen coating, etc. The black photosensitive resin composition thus applied can be patterned through the processes of pre-baking, exposure, development, post-baking, and washing.

The black photosensitive resin composition may include a black pigment, a photopolymerized polymer compound, a photopolymerization initiator, and other additives. Preferably, the black photosensitive resin composition is a negative type of photosensitive resin composition of which the unexposed portion is susceptible to development after exposure. The photopolymerized polymer compound and the photopolymerization initiator may not be specifically limited as long as they are known to be used for the negative type of photosensitive resin composition. The black pigment may include, but is not specifically limited to, any typical black pigment, such as carbon black, perylene black, etc.

As described above, the thickness of the black pattern layer may be in the range from 0.05 μm to 12 μm. Further, the black pattern layer may include a plurality of black patterns including at least one inclined face, which makes an acute angle with the first substrate.

The thickness of the black pattern layer may be controlled within the above-defined range by adjusting the coating thickness of the black photosensitive resin composition or by controlling the conditions for the processes of conducting exposure, development, and washing on the applied black photosensitive resin composition.

On the other hand, the step of forming partition walls may include: applying a photosensitive resin composition onto the first electrode on which the black pattern layer is formed; and conducting exposure, development, and washing on the applied photosensitive resin composition to form partition walls. A mimetic diagram showing the step of forming a partition wall is illustrated in FIG. 12.

The photosensitive resin composition used to form the partition walls may include a photopolymerized polymer compound, a photopolymerization initiator, and other additives, where the photopolymerized polymer compound preferably includes transparent acryl-based polymers, acryal silicone copolymers, or acryl urethane copolymers.

The photosensitive resin composition used to form the partition walls may be applied onto the first electrode on which the black pattern layer is formed, by a coating method including, for example, spin coating, bar coating, screen coating, etc. The photosensitive resin composition thus applied can be patterned through the processes of pre-baking, exposure, development, post-baking, and washing.

10% to 70% of the one side of the partition walls on the first electrode thus obtained may be overlapped with the black pattern layer.

In the step of filling a slurry of charged white particles between the partition walls, a variety of devices such as a nozzle may be used to fill the slurry of charged white particles into each cell or micro-cup of the electrophoretic display device. Then, the second substrate is mounted to have the second electrode face the first electrode and sealed to complete the final product. A mimetic diagram showing the step of filling the slurry of charged white particles and mounting the second substrate is illustrated in FIG. 13.

On the other hand, the method for fabricating the electrophoretic display device may further include preparing charged white particles, and forming a slurry of the charged white particles.

The charged white particles may include a core of inorganic particles capable of representing white, and a shell coating layer including an organic substance controllable in specific gravity and quantity of electric charge and surrounding the core. Examples of the white inorganic particles used for the core may include TiO₂, MgO, ZnO, CaO, ZrO₂, etc.; and examples of the organic substance included in the shell coating layer may include acrylate-based resins, methacrylate-based resins, styrene-based resins, urethane-based resins, silicone-based polymers, melamine resins, mixtures of at least two of these, or their copolymers. The white inorganic particles and the organic substance are blended together and then subjected to suspension polymerization to form the charged white particles.

The slurry of charged white particles may be formed by blending the charged white particles and a rheological fluid together, where the volume ratio of the charged white particles to the rheological fluid ranges from 5:95 to 60:40, preferably from 7:93 to 40:60. The rheological fluid as used herein may be a solvent having a viscosity of 20 cP or less, preferably a hydrocarbon-based solvent having a viscosity of 20 cP or less.

### ADVANTAGEOUS EFFECT OF THE INVENTION

Accordingly, the present invention can provide an electrophoretic display device which exhibits a high contrast ratio and enhanced visibility to realize high-quality text, and a method for fabricating the same.

### BRIEF DESCRIPTION OF THE DRAWINGS

FIG. 1 is a schematic diagram showing the driving mechanism of a conventional micro-cup electrophoretic display.

FIG. 2 is a schematic diagram showing the arrangement of charged white particles when driving a conventional micro-cup electrophoretic e-paper.

FIG. 3 is a schematic diagram showing the driving mechanism of an electrophoretic display device according to one exemplary embodiment of the present invention.

FIG. 4 is a schematic diagram showing exemplary cross-sections of a black pattern.

FIG. 5 is a schematic diagram showing the behavior of charged white particles in an overlapped portion of partition walls and a black pattern in an electrophoretic display device which is displaying black.

FIG. 6 is a schematic diagram showing that the partition walls are overlapped with the black pattern layer.

FIG. 7 is a schematic diagram showing the behavior of charged white particles on the top of the trapezoidal partition walls in an electrophoretic display device which is displaying black.

FIG. 8 is a standard mimetic diagram showing the electrophoretic display device according to one exemplary embodiment of the present invention.

FIG. 9 is a mimetic diagram showing the electrophoretic display device with enhanced whiteness.

FIG. 10 is a mimetic diagram showing an electrophoretic display device with enhanced blackness.

FIG. 11 is a mimetic diagram showing the step of forming a black pattern layer.

FIG. 12 is a mimetic diagram showing the step of forming a partition wall.

FIG. 13 is a mimetic diagram showing the step of filling a slurry of charged white particles and mounting a second substrate.

FIG. 14 is a picture showing the flat surface of the conventional micro-cup electrophoretic display.

FIG. 15 is a picture showing the white particles making a mass on the wall of the cell when the conventional micro-cup electrophoretic display is driven.

FIG. 16 is a picture showing that the conventional micro-cup electrophoretic display is driven.

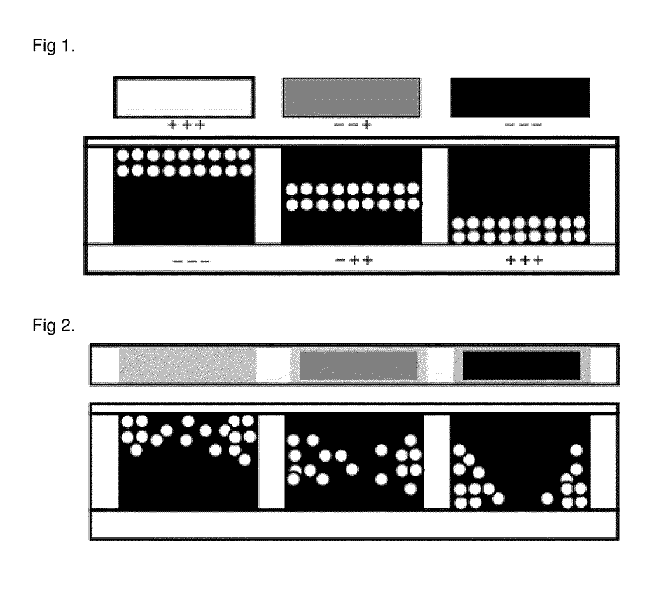

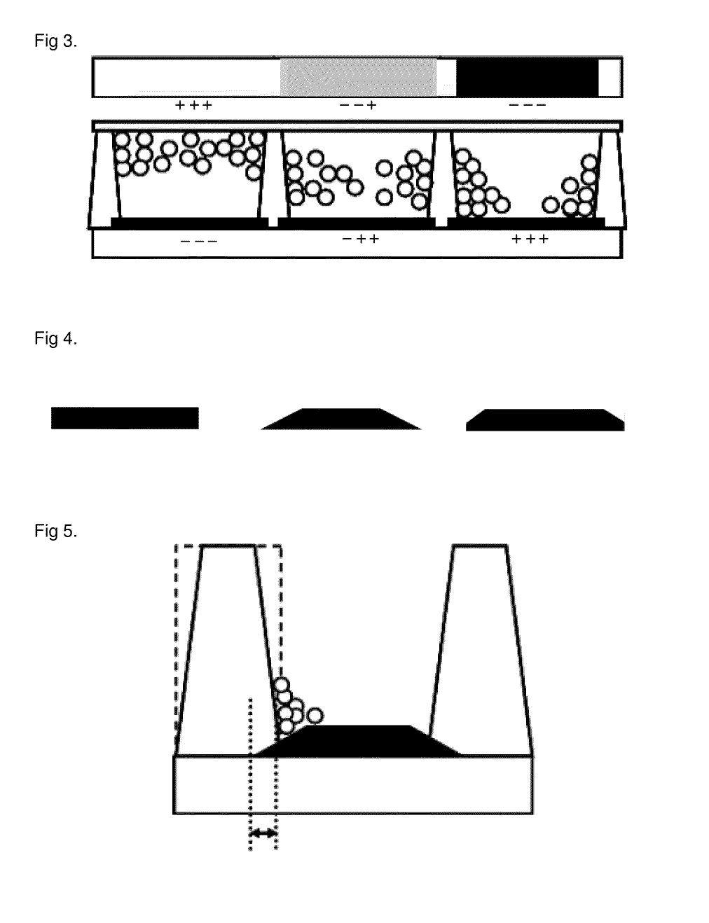

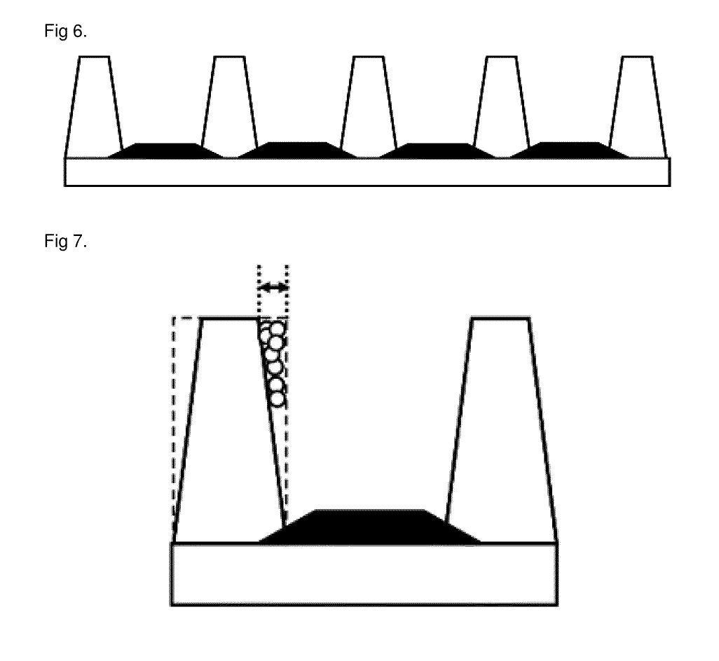

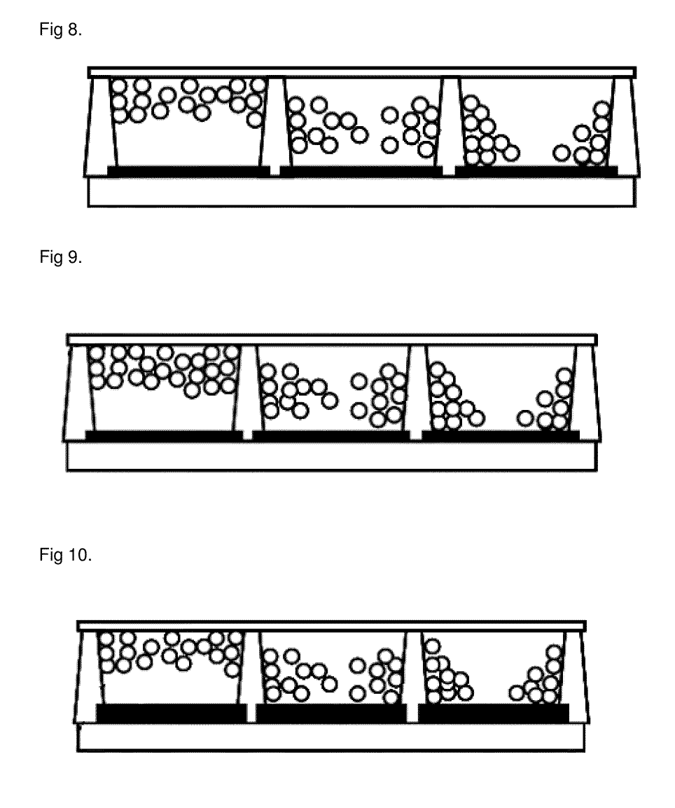

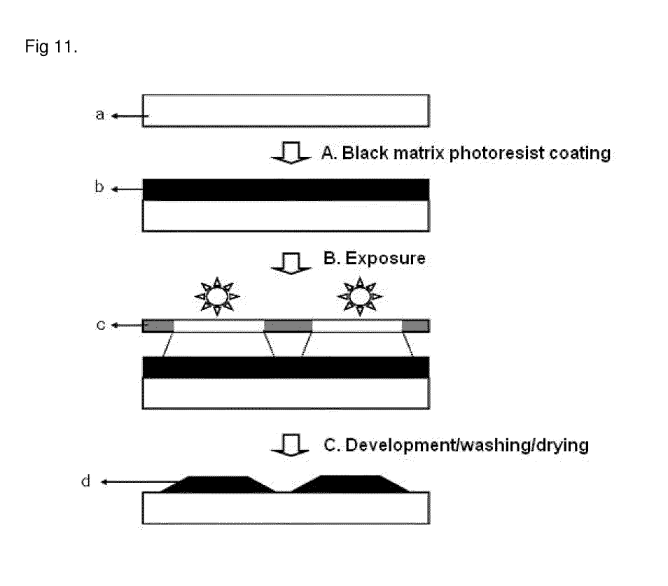

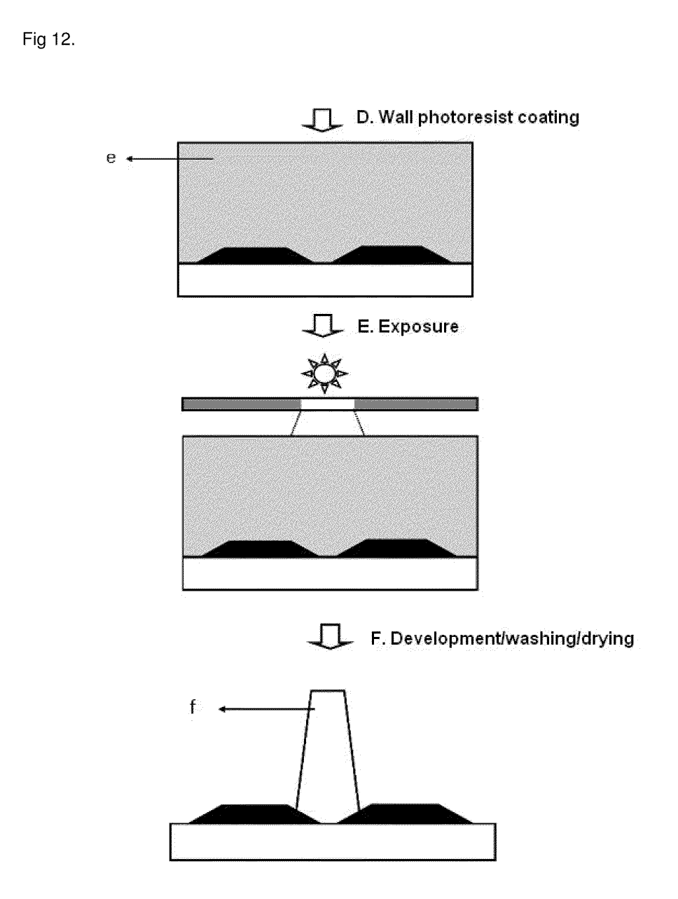

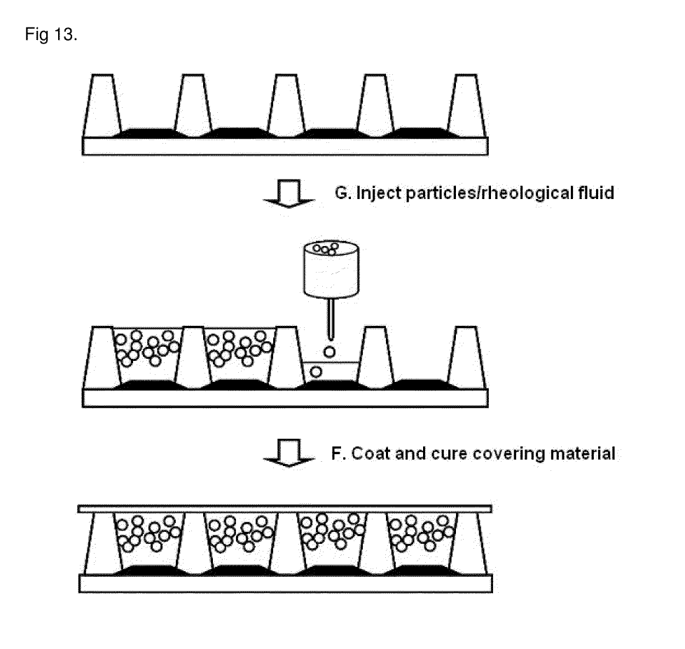

### DETAILS FOR PRACTICING THE INVENTION

The present invention is described in further detail with reference to the following examples, which are intended to exemplify the present invention and should not be construed as limiting the scope of the present invention.

### EXAMPLES

### Fabrication of Electrophoretic Display Device

### Example 1

A black photosensitive resin composition (Onlymer® BM, Kolon Industries Inc.) is spin-coated onto a PET film with an ITO electrode formed thereon and then subjected to the pre-baking, exposure, development, and post-baking processes in sequential order, to form a black pattern layer. In this regard, the spinning speed (rpm) in the spin-coating process is controlled to adjust the thickness of the black pattern layer to 0.1 μm.

A transparent acryl-based photoresist (Onlymer® BM, Kolon Industries Inc.) is spin-coated onto the ITO electrode and the black pattern layer and then subjected to the pre-baking, exposure, development, and post-baking processes in sequential order, to form a partition wall. The spinning speed (rpm) in the spin-coating process is controlled to adjust the height of the partition wall to 30 μm, and the pattern size of a photo-mask is controlled to adjust the thickness of the partition wall to 20 μm.

A mixture containing 20 g of surface-treated charged white particles (TiO₂) and 80 g of a rheological fluid (3 cP) is agitated and maintained in a slurry state.

The slurry of charged white particles thus prepared is injected into the space between the partition walls through a nozzle. Then, another PET substrate with an ITO electrode formed thereon is mounted by sealing it with a urethane acryl-based pressure-sensitive adhesive to complete an electrophoretic display device.

### Example 2

The procedures are performed to fabricate an electrophoretic display device in the same manner as described in Example 1, except for using a slurry containing 19 g of surface-treated charged white particles (TiO₂) and 81 g of a rheological fluid (3 cP) and controlling the black photosensitive resin pattern layer to have a thickness of 2.5 μm by regulating the spinning speed (rpm) in the spin-coating process.

### Example 3

The procedures are performed to fabricate an electrophoretic display device in the same manner as described in Example 1, except for using a slurry containing 22 g of surface-treated charged white particles (TiO₂) and 78 g of a rheological fluid (3 cP) and controlling the black pattern layer to have a thickness of 5 μm by regulating the spinning speed (rpm) in the spin-coating process.

### Example 4

The procedures are performed to fabricate an electrophoretic display device in the same manner as described in Example 1, except for using a slurry containing 25 g of charged white particles and 75 g of a rheological fluid and controlling the black pattern layer to have a thickness of 7.5 μm.

### Reference Example

An observation is made on the actual driving behavior of a conventional micro-cup electrophoretic display device which is fabricated by injecting white particles and a black ink.

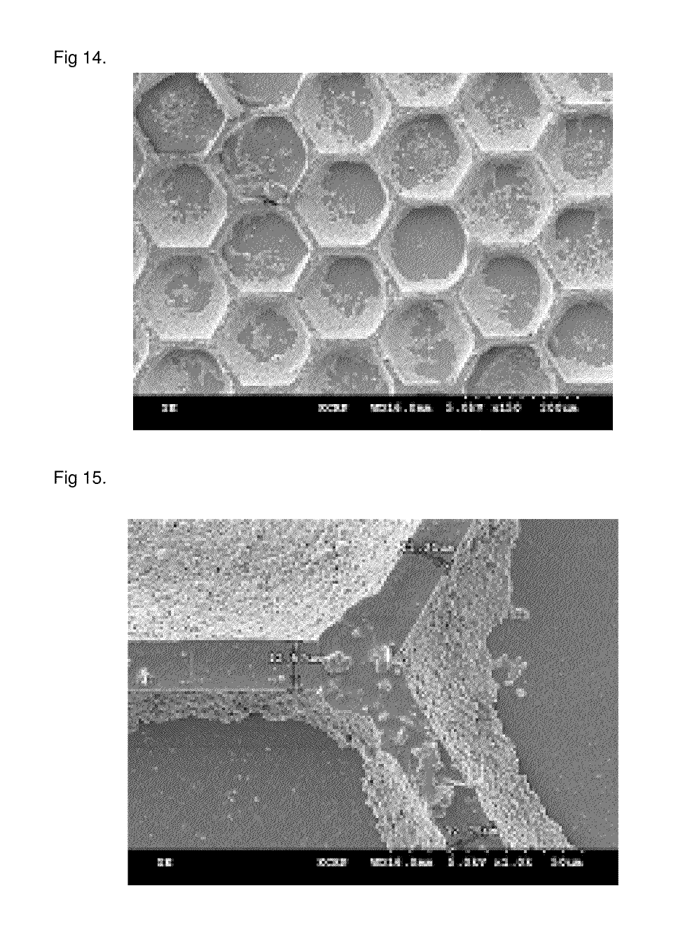

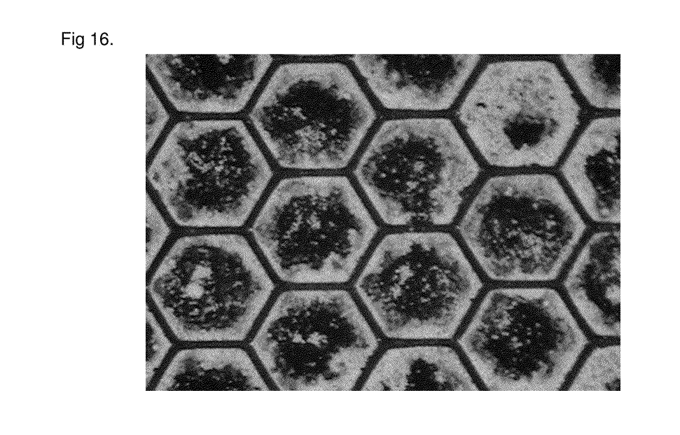

FIG. 14 shows a conventional micro-cup electrophoretic display device, where each cell is defined by partition walls and filled with white particles and a black ink to represent light and shadow on the display. The conventional micro-cup electrophoretic display device encounters a problem, as illustrated in FIG. 15, that the white particles form a mass on the walls of the cell when the display device is driven, resulting in degradation of the contrast ratio. In addition, as shown in FIG. 16, the white particles flow with a non-uniform arrangement during the driving of the display device, to deteriorate the representation of light and shadow.

### Experiment Example 1

### Measurement of Absolute Value of Blackness/Whiteness and Contrast Ratio

The absolute value of blackness for the electrophoretic display devices prior to the injection of charged white particles in the above examples is calculated with a Chroma Meter® CS-100A manufactured by Konica Minolta. The results are presented in Table 1.

TABLE 1
Absolute Value of Blackness/Whiteness and Contrast Ratio

| | Thickness (μm) of black | Absolute value of |
|---|---|---|
| | pattern layer | blackness |
| Example 1 | 0.1 μm | 0.037 |
| Example 2 | 2.5 μm | 0.010 |
| Example 3 | 5 μm | 0.009 |
| Example 4 | 7.5 μm | 0.009 |

As shown in Table 1, the electrophoretic display devices in the examples have a relatively low absolute value of blackness, more specifically, from 0.037 to 0.009, while the black pattern layer has a thickness ranging from 0.1 μm to 7.5 μm.

As can be seen from the results for Examples 1 to 4, the lower blackness is acquired with an increase in the thickness of the black pattern layer. In other words, the electrophoretic display devices of the examples can not only acquire a low blackness and hence a high contrast ratio, but an control the whiteness or blackness simply by regulating the thickness of the black pattern layer or the quantity of the charged white particles while maintaining a high level of the contrast ratio.

### Experiment Example 2

### Measurement of Folding Endurance

The electrophoretic display devices fabricated in the examples are measured with regard to the folding endurance according to ASTM D2176-97 (standard test method for determining folding endurance of paper with the MIT Folding Resistance Tester).

The conditions for the measurements are given as follows. The number of folding cycles made before fracture of each electrophoretic display device is recorded to evaluate the folding endurance. The measurement results are presented in Table 2.

(1) Sample size: 15 mm wide×100 mm long

(2) Folding head radius: 2 mm

(3) Load applied: 2.227 N (0.5 lb)

(4) Folding angle: 135°

(5) Folding speed: 175 cycles/min

TABLE 2
Folding Endurance of Electrophoretic Display Devices

| | Folding Endurance (cycles) |
|---|---|
| Example 1 | 7860 |
| Example 2 | 7710 |
| Example 3 | 7630 |
| Example 4 | 6750 |

As can be seen from Table 2, the electrophoretic display devices with a black pattern layer having a thickness of 0.1 μm to 7.5 μm do not break even partly until more than 6000 cycles of repeated folding, demonstrating their high folding endurance.

### DESCRIPTION OF REFERENCE NUMERALS AND SIGNS

a: PET substrate
b: Black photosensitive resin composition
c: Photo-mask
d: Black pattern
e: Photosensitive resin composition for partition wall
f: Partition wall

What is claimed is:

1. An electrophoretic display device comprising:
first and second substrates separated from each other by a predetermined distance;
first and second electrodes formed on one side of the first and second substrates, respectively, and disposed to face each other;
a black pattern layer formed on the first electrode;
a plurality of partition walls formed between the first and second electrodes, one side of the partition walls on the first electrode being in contact with or overlapped with the black pattern layer; and
a slurry of charged white particles filled between the partition walls.

2. The electrophoretic display device as claimed in claim 1, wherein the black pattern layer has a thickness of 0.05 μm to 12 μm.

3. The electrophoretic display device as claimed in claim 1, wherein the black pattern layer comprises a plurality of white patterns including at least one inclined face.

4. The electrophoretic display device as claimed in claim 3, wherein the inclined face forms an acute angle with the first substrate.

5. The electrophoretic display device as claimed in claim 1, wherein 10% to 70% of one side of a partition wall on the first electrode is overlapped with the black pattern layer.

6. A method for fabricating the electrophoretic display device as claimed in claim 1, comprising:
(a) forming first and second electrodes on one side of first and second substrates separated from each other by a predetermined distance, respectively;
(b) forming a black pattern layer on the first electrode;
(c) forming a plurality of partition walls on the first electrode to cause one side of the partition walls on the first electrode to be in contact with or overlapped with the black pattern layer;
(d) filling a slurry of charged white particles between the partition walls; and
(e) mounting the second substrate to have the second electrode face the first electrode.

7. The method as claimed in claim 6, wherein the step (b) of forming a black pattern layer on the first electrode comprises:
applying a black photosensitive resin composition onto the first electrode; and
conducting exposure, development, and washing steps on the applied black photosensitive resin composition to form a plurality of black patterns.

8. The method as claimed in claim 6, wherein the step (c) of forming partition walls comprises:
applying a photosensitive resin composition onto the first electrode with the black pattern layer formed thereon; and
conducting exposure, development, and washing steps on the applied photosensitive resin composition to form partition walls.

9. The method as claimed in claim 6, further comprising:
preparing charged white particles; and
forming a slurry of the charged white particles.
